(19) United States
(12) Patent Application Publication
(10) Pub. No.: US 2011/0316305 A1
(43) Pub. Date: Dec. 29, 2011

(54) System for Securing Cover to Panel Door of Recreational Vehicle and Living Space Extension for Recreational Vehicle

(75) Inventor: David R. Wysong, Goshen, IN (US)

(73) Assignee: LIPPERT COMPONENTS, INC., Goshen, IN (US)

(21) Appl. No.: 12/822,645

(22) Filed: Jun. 24, 2010

(51) Int. Cl. B60P 3/32; F16B 1/00

(52) U.S. Cl. 296/169; 403/223; 296/172

(57) ABSTRACT

A system for securing a cover to a panel door of a recreational vehicle, the cover typically being a tent, as well as the resultant living space extension for the vehicle. An elongated, rigid extrusion is secured peripherally to the panel door, and an elongated channel is shaped to fit in a cavity of the extrusion and be retained in place, with the channel being stitched to the bottom skirt of the cover. With the channel engaged on the extension, the cover is retained essentially permanently in engagement on the panel door.

### BACKGROUND OF THE INVENTION

This invention relates to recreational vehicles, and in particular to a living space extension for a recreational vehicle, typically for a tent attachment.

Recreational vehicles are becoming more sophisticated, with slide out rooms and tent attachments, with the typical tent attachments being located on a panel door that is movable from a stowed position to an operational position. Typically, in the past, the skirt of the tent is attached to the panel door by means of a hook-and-loop attachment mechanism, which, although holding the tent in place, cannot bear much force before the hook portion of the hook-and-loop fastener separates from the loop portion of the hook-and-loop fastener.

Various means have been proposed for securing a flexible cover of some sort to a vehicle or the like. For example, U.S. Pat. No. 5,702,147 discloses a sealing arrangement for the tailgate of a vehicle for a removable and flexible top. U.S. Pat. No. 6,145,525 discloses attachment of a tent-like shelter to a rigid outdoor cabinet. U.S. Pat. No. 6,588,361 discloses a particular means of fastening a flexible cover to a boat for protecting the boat interior. Published U.S. Application No. US 2007/0120396 discloses a means of securing a tent attachment to a recreational vehicle for deployment and storage.

### SUMMARY OF THE INVENTION

The invention is directed to a system for securing a cover to a panel door of a recreational vehicle, and the resulting living space extension. The system comprises two elements. First is an elongated, rigid extrusion having a center cavity, with an elongated rigid projection extending into the cavity. The projection has at least one rigid retention component. The second element comprises an elongated channel shaped to fit in the cavity and engage the projection. The channel has at least one flexible retention component complementary to the rigid retention component.

In accordance with the preferred form of the invention, the retention component comprises a barb. The flexible retention component of the elongated channel comprises a tab. Preferably there is a plurality of the barbs located on opposite sides of the projection, and there is a like plurality of the tabs, each tab being in registration with one of the barbs when the rigid projection is engaged in the channel.

The extrusion has spaced mounting flanges which are shaped to be secured to a peripheral margin of the panel door in order to maintain the extrusion in place on the panel door. A sealing flange, used when the door is in a stowed position, is formed in the extrusion, extending from the extrusion opposite the mounting flanges.

The living space extension for a recreational vehicle comprises a panel shaped to be moved from a stowed position to a substantially horizontal operational position, the panel, in the operational position, comprising at least a portion of a floor for the extension. A cover is provided, the cover being formed to create a living space above the panel and contiguous to the recreational vehicle when the panel is in the operational position. A system is provided for securing the cover to the panel, the system comprising first and second elements connected to the cover. One of the elements comprises an elongated, rigid projection having at least one rigid retention component, and the other of the elements comprises a channel shaped to engage the projection and having at least one flexible retention component complementary to the rigid retention component.

In accordance with the preferred form of the invention, the panel is hingedly secured to the recreational vehicle, with the panel, in the stowed position, forming an exterior wall for the recreational vehicle. The cover comprises a tent that is deployed when the exterior wall is in the operational position.

The rigid retention component comprises a barb. The flexible retention component comprises a tab. Preferably, there is a plurality of the barbs located on opposite sides of the projection, and there is also a plurality of the tabs, with each tab being in registration with one of the barbs when the rigid projection is engaged in the channel.

In accordance with the preferred form of the invention, the projection is located on an elongated extrusion, the extrusion having spaced mounting flanges shaped to be secured to a peripheral margin of the panel. The projection is located in a cavity in the extrusion. A sealing flange may also be provided, extending from the extrusion opposite the mounting flanges, with the sealing flange forming a seal when the panel is in the stowed position.

### BRIEF DESCRIPTION OF DRAWINGS

The invention is described in greater detail in the following description of examples embodying the best mode of the invention, taken in conjunction with the drawing figures, in which:

FIG. 1 is an isometric view of a typical recreational vehicle, showing a living space extension according to the invention,

FIG. 2 is an enlarged view of one corner of the living space extension of FIG. 1, showing detail,

FIG. 3 is a further enlarged view taken along lines 3-3 of FIG. 2, with portions removed, showing detail of the system for securing the tent to the panel door, and

FIG. 4 is a view similar to FIG. 3, but with the two portions of the system disengaged.

### DESCRIPTION OF EXAMPLES EMBODYING THE BEST MODE OF THE INVENTION

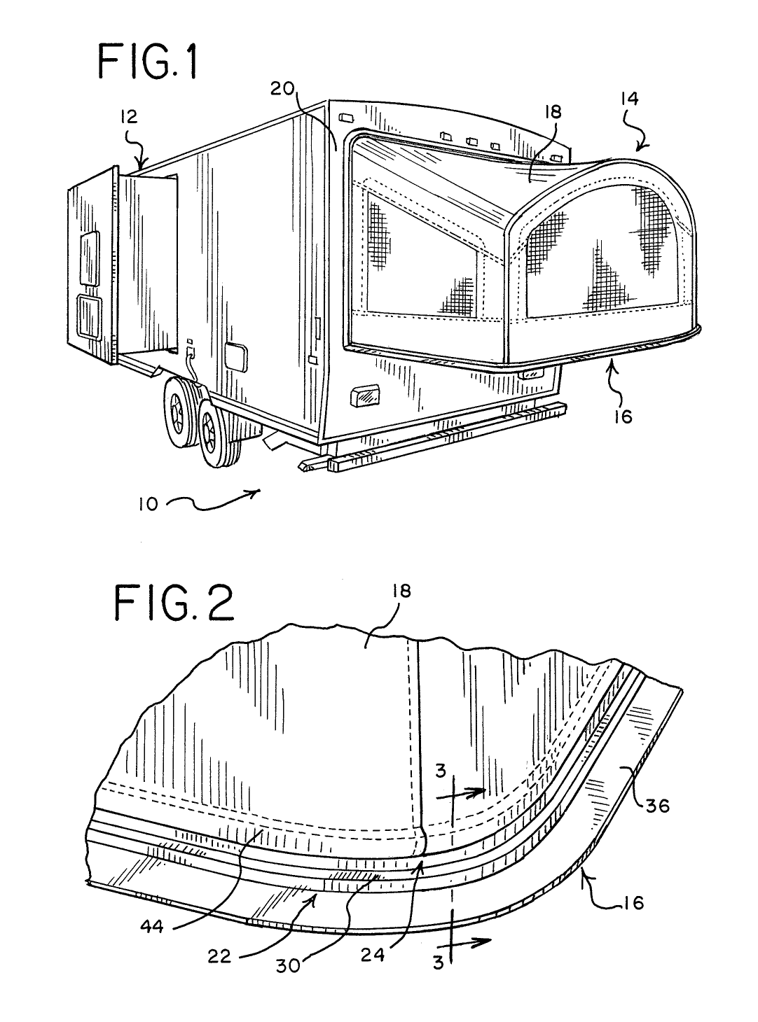

A typical recreational vehicle employing the invention is shown generally at 10 in FIG. 1. While the vehicle 10 is shown in FIG. 1 is what is known as a fifth wheel, that is for illustrative purposes, only, and any type of recreational vehicle can employ the invention, and, indeed, the invention can be employed in other types of vehicles and other types of deployment where a stowable and extendable living space extension is needed.

The recreational vehicle 10 is typical, and is therefore not described in detail. It employs two extendable elements, a slide out room 12 and a living space extension 14. It is the living space extension 14 that is the primary focus of this invention.

The living space extension 14 includes two major components, a panel 16 which is shaped to be moved from a stowed position to a substantially operational position, and a cover 18, typically a tent, which is secured to both the panel 16 and the recreational vehicle 10 so that, as shown in FIG. 1, when the panel is moved from the stowed position to the operational position shown, the panel comprises at least a portion of a floor for the living space extension 14. The panel 16 can be a typical panel which, when returned to the stowed position in a typical fashion, forms part of the rear wall 20 of the recreational vehicle 10. The panel 16, therefore, is not described in greater detail.

The tent 18 can also be conventional. It is typically accessed from the interior of the recreational vehicle 10, although it may include zippered or other type of entry from the exterior, as well. The tent 18 is typically formed from a flexible material that can be folded into a stowed orientation when the panel 16 is moved to the stowed and closed position. This is well known and conventional.

A critical location is the union between the panel 16 and the tent 18. If the tent 18 is not appropriately affixed to the panel 16, there is the possibility that the two can separate, and a person in the living space extension 14 could fall from the recreational vehicle 10. Therefore, the junction of the lower skirt of the tent 18 to the panel 16 is critical.

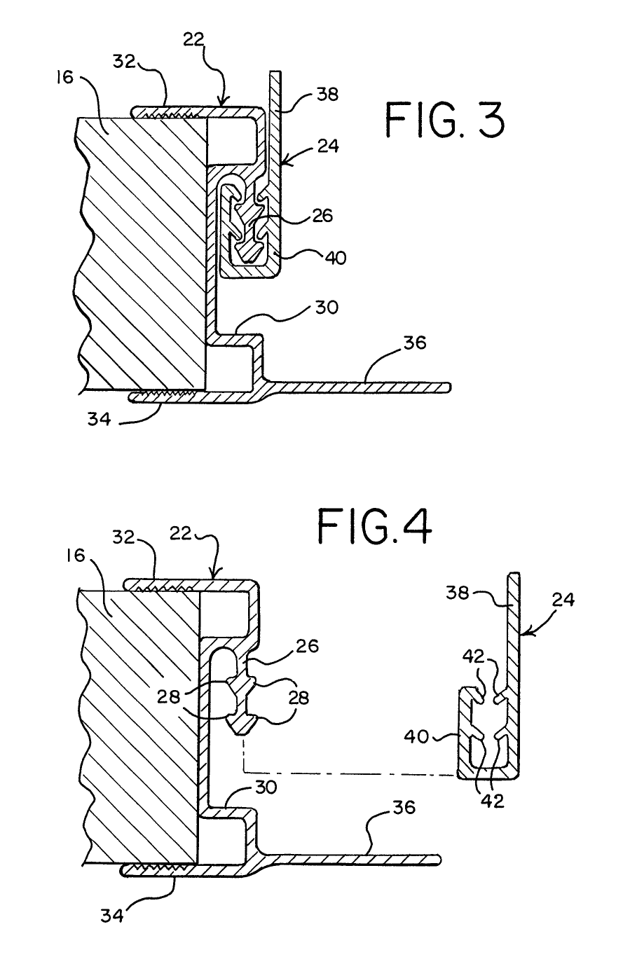

FIG. 3 illustrates a section through the lower skirt of the tent 18, where it is secured to the panel 16. That is shown in FIG. 3, and for the sake of clarity of illustration, the tent 18 is eliminated.

For securing the tent 18 to the panel 16, two elements are employed, an elongated, rigid extrusion 22 and an elongated channel 24. The channel 24 comprises a first element connected to the cover and the extrusion 22 comprises a second element connected to the panel door 16.

The extrusion 22 may be formed of aluminum, any other metal, or any other material that is sufficiently rigid, and includes an elongated, rigid projection 26. The projection 26 includes a series of rigid retention components in the form of barbs 28. The projection is located in a cavity 30 formed in the extrusion 22.

The extrusion 22 includes spaced mounting flanges 32 and 34 shaped to be secured to a peripheral margin of the panel 16. As shown, the mounting flanges 32 and 34 include teeth engaging the panel 16, which may be sufficient for a friction fit between the extrusion 22 and the panel door 16 to hold the extrusion 22 in place. If not, however, various types of fasteners, not illustrated, can be employed to securely retain the extrusion 22 on the panel 16.

When the panel 16 is in the stowed position, it forms part of the rear wall 20 of the recreational vehicle 10. To help effect a seal, the extrusion 22 can also include a sealing flange 36, as shown.

The channel 24 includes a leg 38 extending from a U-shaped portion 40. The channel 24 is formed of a more flexible material than the extrusion 22, such as being formed from plastic, but is sufficiently rigid so that when it is engaged on the projection 26 as shown in FIG. 3, that combination is locked securely in place. To that end, the U-shaped portion 40 includes flexible retention components in the form of a series of tabs 42. The tabs 42 are complementary to the barbs 28 so that when the channel 24 is in engaged on the projection 26 as shown in FIG. 3, the channel 24 is rigidly retained on the extrusion 22, and cannot be removed except with exceptional force, well above that encountered during normal use.

The channel 24 can be appropriately secured to the tent 18. One means is by stitching 44, shown in FIG. 2. Other conventional means of attachment can be employed, as well.

Various changed may be made to the invention without departing from the spirit thereof or scope of the following claims.

What is claimed is:

1. A living space extension for a recreational vehicle, the extension comprising:
a. a panel shaped to be moved from a stowed position to a substantially horizontal operational position, said panel, in said operational position, comprising at least a portion of a floor for the extension,
b. a cover formed to create a living space above said panel and contiguous to the recreational vehicle when said panel is in said operational position, and
c. a system for securing said cover to said panel, said system comprising a first element connected to said panel and a second element connected to said panel, one of said elements comprising an elongated, rigid projection having at least one rigid retention component, and the other of said elements comprising a channel shaped to engage said projection and having at least one flexible retention component complementary to said rigid retention component.

2. The living space extension according to claim 1, in which said panel is hingedly secured to the recreational vehicle, said panel, in said stowed position, forming an exterior wall for the recreational vehicle.

3. The living space extension according to claim 1, in which said cover comprises a tent.

4. The living space extension according to claim 1, in which said rigid retention component comprises a barb.

5. The living space extension according to claim 4, in which said flexible retention component comprises a tab.

6. The living space extension according to claim 4, including a plurality of said barbs located on opposite sides of said projection.

7. The living space extension according to claim 6, in which said retention component comprises a plurality of tabs, each in registration with one of said barbs when said rigid projection is engaged in said channel.

8. The living space extension according to claim 1, in which said projection is located on an elongated extrusion, said extrusion having spaced mounting flanges shaped to be secured to a peripheral margin of said panel.

9. The living space extension according to claim 8, in which said projection is located in a cavity in said extrusion.

10. The living space extension according to claim 8, including a sealing flange extending from said extrusion opposite said mounting flanges.

11. A living space extension for a recreational vehicle, the extension comprising:
a. a panel hingedly secured to the recreational vehicle and shaped to be moved from a vertical stowed position to a substantially horizontal operational position,
b. a cover formed to create a living space above said panel and contiguous to the recreational vehicle when said panel is in said operational position, and
c. a system for securing said cover to said panel, comprising
i. an elongated extrusion secured to a peripheral margin of said panel, said extrusion including an elongated, rigid projection having at least one rigid retention component, and
ii. a channel on a bottom skirt of said cover and shaped to engage said projection, said channel having at least one flexible retention component complementary to said rigid retention component.

12. The living space extension according to claim 11, in which said cover comprises a tent.

13. The living space extension according to claim 11, in which said rigid retention component comprises a barb.

14. The living space extension according to claim 13, in which said flexible retention component comprises a tab.

15. The living space extension according to claim 13, including a plurality of said barbs located on opposite sides of said projection.

16. The living space extension according to claim 15, in which said retention component comprises a plurality of tabs, each in registration with one of said barbs when said rigid projection is engaged in said channel.

17. The living space extension according to claim 11, in which said projection is located in a cavity in said extrusion.

18. The living space extension according to claim 11, including a sealing flange extending outwardly from said extrusion.

19. A system for securing a cover to a panel door of a recreational vehicle, comprising two elements:
a. an elongated, rigid extrusion having a center cavity, with an elongated rigid projection extending into said cavity, said projection having at least one rigid retention component, and
b. an elongated channel shaped to fit in said cavity and engage said projection, said channel having at least one flexible retention component complementary to said rigid retention component.

20. The system according to claim 19, in which said rigid retention component comprises a barb.

21. The system according to claim 20, in which said flexible retention component comprises a tab.

22. The system according to claim 20, in which including a plurality of said barbs located on opposite sides of said projection.

23. The system according to claim 22, in which said retention component comprises a plurality of tabs, each in registration with one of said barbs when said rigid projection is engaged in said channel.

24. The system according to claim 19, in which said extrusion has spaced mounting flanges shaped to be secured to a peripheral margin of the panel door.

25. The system according to claim 24, including a sealing flange extending from said extrusion opposite said mounting flanges.
